(19) United States
(12) Patent Application Publication
(10) Pub. No.: US 2013/0011217 A1
(43) Pub. Date: Jan. 10, 2013

(54) Rivet With Improved Contact Surface

(76) Inventor: Guy Avellon, Chicago, IL (US)

(21) Appl. No.: 13/179,165

(22) Filed: Jul. 8, 2011

(51) Int. Cl. F16B 19/00; B21K 1/46; F16B 19/04

(52) U.S. Cl. 411/500; 72/356

(57) ABSTRACT

A mechanical fastener having improved friction and torsional resistance is provided. The mechanical fasteners can be made using a cold heading process with modified dies abutting the underside of the flange of a mechanical fastener to provide a corrugated or abrasive contact surface.

### TECHNICAL FIELD

The description herein relates to mechanical fasteners such as rivets that have an improved contact surface that increases torsional resistance.

### BACKGROUND

Rivets are mechanical fasteners that can be used to permanently affix two structures. Rivets usually consist of a head, or flange, and a shaft that is inserted into one or more structures. These mechanical fasteners can support tension loads (forces that are parallel to the shaft) and shear loads (forces that are perpendicular to the shaft) up to certain limits depending on the material composition of the rivet and the structures being affixed.

A problem faced by truckers are the loosening of rivets used to fasten truck brake linings. This problem is most commonly faced by many drivers of intercity vehicles due to their constant stop and go and back-up driving situations.

### BRIEF SUMMARY

Provided herein is a mechanical fastener comprising a flange section that has a first diameter and a shaft section with a second diameter. The flange section is adjacent to the shaft section. The first diameter of the flange section has a greater diameter than the second diameter of the shaft section. The flange section has a contacting side comprised of a corrugated surface to provide torsional resistance when the contacting side abuts an object to be fastened by the mechanical fastener. The shaft section is adjacent to the contacting side of the flange section. The corrugated surface can comprise ridges having height or a plurality of knurls having height. The ridges can comprise inclined ramps sloping from the contacting side to the height of the ridge.

The ridges can be equally spaced around the contacting side and elongated in a generally axial direction. The ridges also can be equally spaced and parallel to one another or skewed on the contacting side. The ridges can be arranged in concentric circles having a shared center with the shaft section. The height of the ridges or the knurls can be up to about 0.02 inches or from about 0.010 inches to about 0.015 inches.

The mechanical fastener can be a rivet, nail, bolt, screw, or the like. The shaft section can comprise an inclined plane.

Also described herein is a method for making a mechanical fastener that provides increased friction and torsional resistance. The method comprises providing a blank having a first section and a second section. The blank is inserted into a first die where a flange is formed from the first section by a blow from a ram or hammer. The flange has a proximal portion and a distal portion. The blank is inserted into a second die which has a corrugated pattern that contacts the distal portion of the flange. Striking the blank against the second die such that a contacting surface is formed on the distal portion of the flange section. The contacting surface has an imprint from the corrugated pattern.

### BRIEF DESCRIPTION OF THE DRAWINGS

FIG. 1 is a side elevational view of a prior art mechanical fastener.

FIG. 2a is a side elevational view of a mechanical fastener with a corrugated contact surface of ridges arranged in a pattern of concentric circles.

FIG. 2b is a view of the contact surface on the underside of the mechanical fastener shown in FIG. 2a.

FIG. 3a is a side elevational view of a mechanical fastener with a corrugated contact surface of parallel ridges.

FIG. 3b is a view of the contact surface on the underside of the mechanical fastener shown in FIG. 3a.

FIG. 4a is a side elevational view of a mechanical fastener where the corrugated contact surface has ramped ridges arranged coaxially around the shaft of the mechanical fastener.

FIG. 4b is a view of the contact surface on the underside of the mechanical fastener shown in FIG. 4a.

FIG. 5 is a side elevational view of a mechanical fastener with a contact surface having a plurality of knurls positioned around the distal portion of the mechanical fastener flange.

FIG. 6 shows a step-by-step process for making mechanical fastener using a cold heading process.

FIG. 7 shows a die that can be used to make a mechanical fastener with knurls on the contacting surface.

### DETAILED DESCRIPTION

The embodiments of the present invention provide a mechanical fastener, such as a rivet, nail, bolt, screw, or the like, with an improved contacting surface that aids in preventing movement of the installed fastener. When the described enhancements are used with other fastening devices, such as nuts, machine screws or small bolts, this feature would prevent rotation of that part by means of embedment into a softer joint material when assembled on one side of a joint connection, without having to secure said part while tightening. The contacting surface comprises ridges or knurls formed by a die during the manufacturing process. An automatic cold heading process may be used to form the fasteners described herein. When fastened to a material, the fasteners with the contacting surface described herein exhibit increased friction and torsional resistance compared to fasteners in the prior art that lack such a contacting surface.

The ridges can have a radial formation or axially placed around the flange section of a mechanical fastener. There can be a plurality of distinct knurls placed throughout the contacting surface each having a distinct height. The height of the ridges or knurls can be up to about 0.020 inches or from about 0.010 inches to about 0.015 inches and all combinations and sub-combinations therein. The knurls can be the same or have varying heights. The ridges or knurls of the contacting surface will dig into the abutted material to provide increased friction and torsional resistance. The ridges and knurls described herein can be arranged on the contacting side to resist shear forces and to maximize friction and torsional resistance. The mechanical fasteners described herein also prevent lateral movement in all directions.

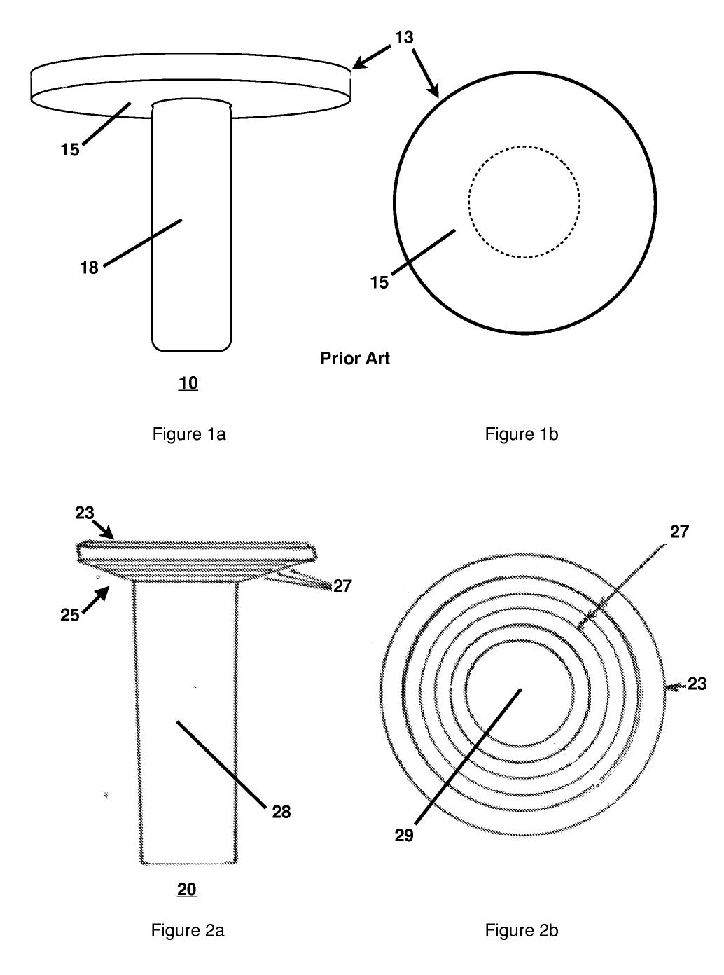

Prior art mechanical fasteners 10, as shown in FIGS. 1a and 1b, generally have a head 13 and a shaft 18 section. The underside 15 of the head 13 contacts a plate or other planar surface to be fastened. The underside 15 of prior art mechanical fasteners 10 are smooth and flatly contact adjacent planar surfaces. These fasteners are prone to loosening when met with shearing forces.

Mechanical fastener 20 in FIGS. 2a and 2b comprises a flange section 23 having a first diameter and a shaft section 28 having a second diameter. The underside of the flange 23 section is a contacting side 25 that comprises ridges 27 that embed into a material to be fastened and helps resist shear forces. The ridges 27 have height, or depth depending on the orientation of the fastener 20, to provide friction and torsional resistance when abutting an object to be fastened. The flange 23 section also is tapered from the outer edge to the shaft 28 section. The ridges 27 in FIG. 2b are arranged in concentric circles that share a center 29 with the shaft section 28. The ridges 27 are equally spaced from the center to the edge of the flange 23 section. However, there may be embodiments where the spaces between the ridges 27 may vary. The heights of the ridges need not be uniform in some embodiments.

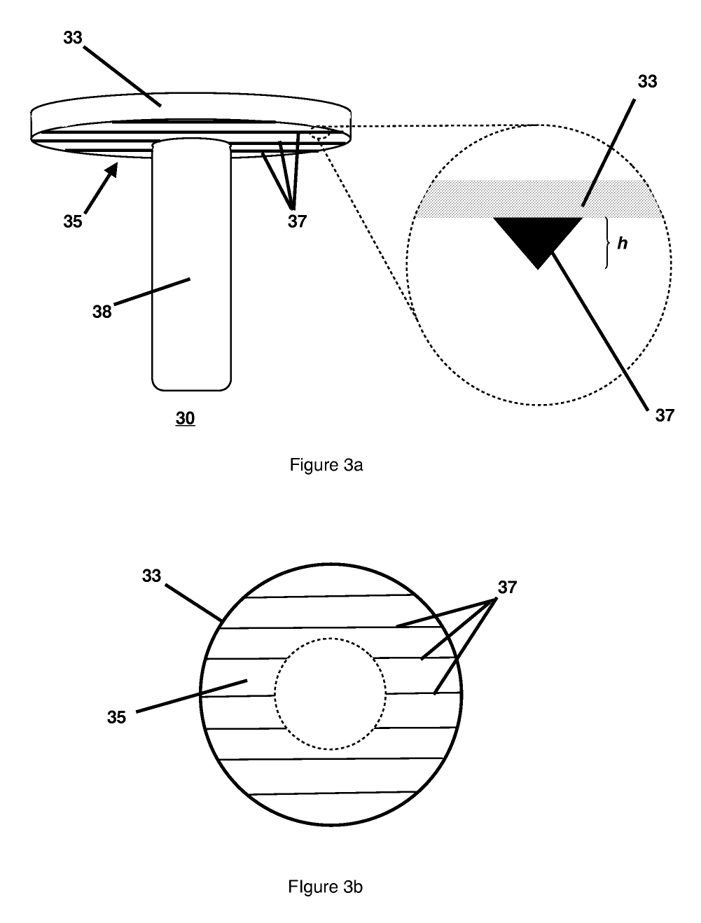

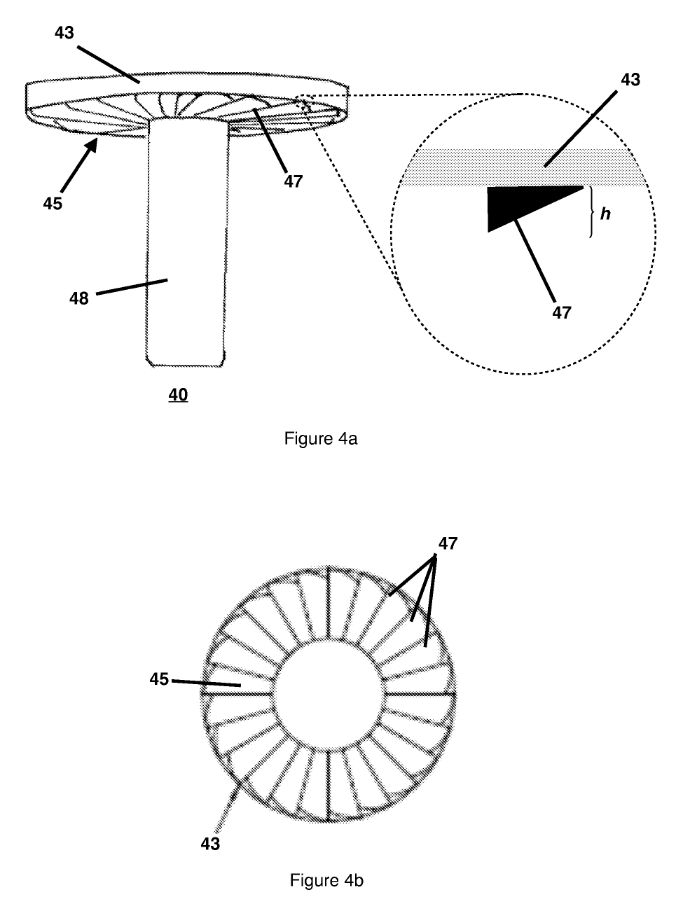

The height (h) of a ridge 37 is shown in FIG. 3a. Mechanical fastener 30 comprises a contacting side 35 with ridges 37 that are equally spaced and are parallel to one another. The ridges 37 appear as horizontal lines in FIGS. 3a and 3b. The height h can be up to about 0.02 inches. The height h also can be from about 0.010 inches to about 0.015 inches. The height h can be adjusted depending on a number of variables including, for example, the materials to be fastened, an estimate of the forces (torsional, shear, friction) to be placed on the fastener, and the material of the fastener.

Ridge 37 is shown having a triangle cross-section. However, the cross-section of the ridges of the present invention may come in different shapes that can be determined by the die used in the formation process.

Mechanical fastener 40 is a hex machine screw or SEMS type of flanged screw. Fastener 40 comprises ridges 47 with inclined ramps that slope from the contacting side 45 to the height of the ridge. The ridges 47 can be axially arranged around the contacting side 45, resembling a sunflower pattern, as shown in FIGS. 4a and 4b. The h in the zoom insert of FIG. 4a can be up to about 0.02 inches or from about 0.010 inches to about 0.015 inches or can be adjusted accordingly as discussed above. Fastener 40 can be used to prevent or decrease the likelihood of counter-rotation and loosening after assembly. The ridges 47 may be arranged in a clockwise direction in other embodiments.

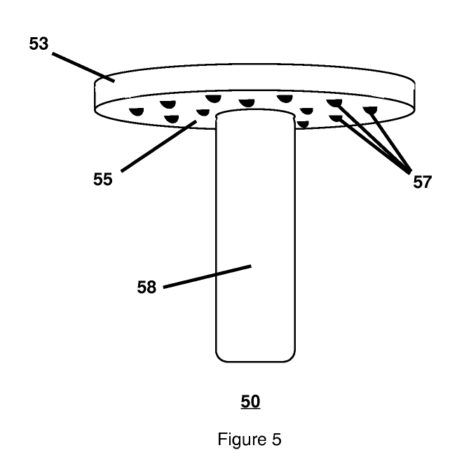

The contacting side of the mechanical fasteners of the present invention can have corrugated or abrasive patterns. The contacting side 55 of mechanical fastener 50 has an abrasive texture provided by a plurality of knurls 57 as shown in FIG. 5. The knurls can also be granular, having the consistency of sandpaper. The mechanical fastener 50 can be used when fastening particularly hard materials such as cast, wrought or extruded iron, steel, or aluminum alloys.

A cold heading process can be used to form the mechanical fasteners of the present invention. Bolt makers or nut formers modified as described herein also can be used. A coil of wire is fed through straightening rollers, optionally, passing through reducing dies. The wire then is fed into the machine where a length is cut to proper dimension to form a blank that will eventually form the shaft and flange sections. A series of transfer fingers move the blank from one forming station to another. The forming stations contain dies into which the blank is inserted to be shaped.

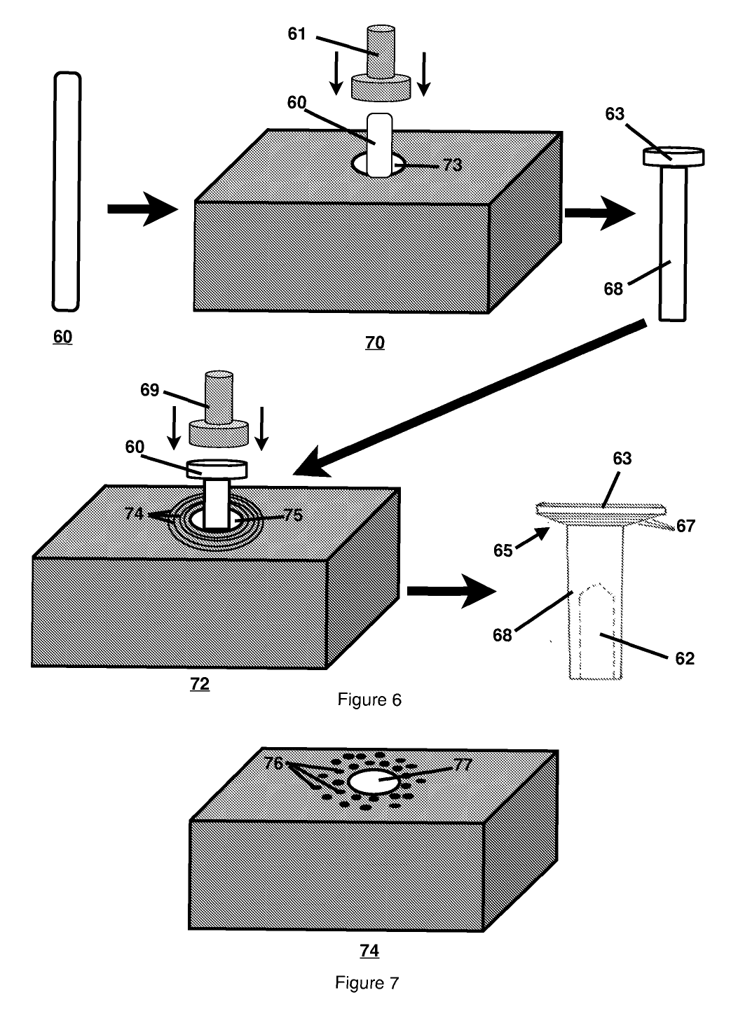

FIG. 6 shows a simplified form of a cold headed process used to form a mechanical fastener of the present invention. Blank 60 is provided having a proximal side and a distal side. The proximal side of blank 60 will form a flange and the distal side will form a shaft section. Blank 60 is inserted into slot 73 of die 70 and struck by hammer 61 in the direction of the arrows to shape the metal of the blank 60 into a flange 63. The flange 63 has a proximal side and a distal side. The remaining distal side of the blank 60 becomes shaft 68.

The blank 60 is then moved to die 72 which has a corrugated pattern. Die 72 has ridges 74 having depth arranged in concentric circles radiating from slot 75. The ridges can have a depth of up to about 0.020 inches or from about 0.010 to about 0.015 inches, and all combinations and sub-combinations therein. Blank 60 is inserted into slot 75 such that the distal side of the flange 63 abuts the corrugated pattern of die 72. The die 72 that shapes and forms the conical angle under flange 63 can be grooved. This will allow metal to flow into the grooves, which will produce the ridges 67 on the contacting side 65. Hammer 69 strikes flange 63 against die 72 thereby leaving a corrugated imprint on the distal side of flange 63. The imprint of the corrugated pattern comprises ridges 67 having heights that correspond to the depths of ridges 74. The distal side of flange 63 becomes contacting side 65 which exhibits friction and torsional resistance features. Depending upon how the process is designed, during forming, a pin can be rammed into the distal side of the blank 68 to form an interior cavity 62.

FIG. 7 shows a die having a corrugated pattern that comprises a plurality of depressions 76 having depth. A blank with a flange can be inserted into slot 77 such that the distal side of the flange contacts the depressions 76. After the flange is struck by a hammer, the imprint formed on the contacting side of the flange are knurls that have height corresponding to the depth of the depressions.

It is understood that other variations of the mechanical fastener and method may be employed. The number of ridges formed may vary as well as the number of knurls. The heights of the ridges and knurls can also vary depending on the amount of force to be resisted. The spacing of the ridges and knurls can also vary. Instead of parallel ridges, some contacting surfaces may be skewed. A variety of mechanical fasteners can be formed including screws, rivets, nails, or bolts.

1. A mechanical fastener comprising
a flange section adjacent to a shaft section;
said flange section has a contacting side comprised of ridges having height to provide friction and torsional resistance when abutting an object to be fastened; and
said shaft section being adjacent to said contacting side.

2. The mechanical fastener of claim 1, wherein said ridges are parallel to one another or skewed.

3. The mechanical fastener of claim 1, wherein said ridges comprise inclined ramps sloping from said contacting side to the height of said ridge.

4. The mechanical fastener of claim 3, wherein said ridges are axially arranged around the contacting side.

5. The mechanical fastener of claim 1, wherein said ridges are equally spaced to one another.

6. The mechanical fastener of claim 1, wherein said ridges are arranged in concentric circles having a shared center with the shaft section.

7. The mechanical fastener of claim 1, wherein said height is up to about 0.02 inches.

8. The mechanical fastener of claim 1, wherein said height is from about 0.010 inches to about 0.015 inches.

9. The mechanical fastener of claim 1, wherein the mechanical fastener is a rivet, nail, bolt, screw.

10. A mechanical fastener comprising
a flange section adjacent to a shaft section;
said flange section has a contacting side comprised of a plurality of knurls having height to provide friction and torsional resistance when abutting an object to be fastened; and
said shaft section being adjacent to said contacting side.

11. The mechanical fastener of claim 10, wherein said knurls have varying heights.

12. The mechanical fastener of claim 10, wherein said height is up to about 0.02 inches.

13. The mechanical fastener of claim 10, wherein said height is from about 0.010 inches to about 0.015 inches.

14. The mechanical fastener of claim 10, wherein the mechanical fastener is a rivet, nail, bolt, screw.

15. A method of making a mechanical fastener with an improved contact surface that provides increased friction and torsional resistance, said method comprising
providing a blank having a first section and a second section;
inserting said blank into a first die where a flange is formed from said first section by a blow to said first section, said flange having a proximal portion and a distal portion;
inserting said blank into a second die having a corrugated pattern that contacts said distal portion of said flange;
striking said blank against said second die such that a contacting surface is formed on said distal portion of said flange section; and
wherein said contacting surface has an imprint from said corrugated pattern.

16. The method of making a mechanical fastener of claim 15, wherein said imprint comprises ridges having height or a plurality of knurls having height.

17. The method of making a mechanical fastener of claim 16, wherein said ridges comprise inclined ramps sloping from said contacting side to the height of said ridge.

18. The method of making a mechanical fastener of claim 16, wherein said ridges are arranged in concentric circles.

19. The method of making a mechanical fastener of claim 16, wherein said height is up to about 0.02 inches.

20. The method of making a mechanical fastener of claim 16, wherein said height is from about 0.010 inches to about 0.015 inches.
